(19) United States
(12) Patent Application Publication
(10) Pub. No.: US 2014/0148137 A1
(43) Pub. Date: May 29, 2014

(54) CONVERSATION METHOD AND TERMINAL

(71) Applicant: Tencent Technology (Shenzhen) Company Limited, Shenzhen (CN)

(72) Inventors: Yueteng Weng, Shenzhen (CN); Shaomian Yao, Shenzhen (CN); Tianqing Huang, Shenzhen (CN); Bin Zhang, Shenzhen (CN)

(73) Assignee: Tencent Technology (Shenzhen) Company Limited, Shenzhen (CN)

(21) Appl. No.: 14/012,954

(22) Filed: Aug. 28, 2013

Related U.S. Application Data
(63) Continuation of application No. PCT/CN2013/079012, filed on Jul. 8, 2013.

(30) Foreign Application Priority Data
Nov. 28, 2012 (CN) 201210492971.3

(51) Int. Cl. H04W 4/16

(52) U.S. Cl. CPC H04W 4/16
USPC 455/414.1

(57) ABSTRACT

A conversation method is performed at a first mobile communication terminal. The method includes: receiving a conversation request from a second mobile communication terminal, the conversation request containing a call invitation request that expires after a first time period; displaying the call invitation request; establishing a call connection with the second terminal in response to detecting a first predefined user operation on the call invitation request within the first time period; replacing the display of the call invitation request with the display of the conversation request after the first time period, the conversation request further including a call initiation command that expires after a second time period; and initiating a call to the second terminal if detecting a second predefined user operation on the call initiation command after the first time period and within the second time period, the second time period being longer than the first time period.

### RELATED APPLICATION

This application is a continuation application of PCT Patent Application No. PCT/CN2013/079012, entitled “CONVERSATION METHOD AND APPARATUS, AND TERMINAL” filed on Jul. 8, 2013, which claims priority to Chinese Patent Application No. 201210492971.3, entitled “CONVERSATION METHOD AND APPARATUS, AND TERMINAL” and filed on Nov. 28, 2012, both of which are incorporated by reference in their entirety.

### TECHNICAL FIELD

The disclosed implementations relate generally to the field of communications technologies, and in particular, to a conversation method and apparatus, and a terminal

### BACKGROUND

A conventional conversation process mainly includes three stages. The first stage is a request stage: a calling end performs a call operation for a called end (for example, the calling end initiates the call operation by dialing a number of the called end); initiates a call request to the called end; and before the called end returns a call response, a user of the calling end can select to hang up. The second stage is a response waiting stage: after receiving the call request, the called end plays a ring, to prompt a user of the called end to answer a call or hang up; in this stage, if the user of the called end selects to hang up, the call of the calling end fails, and the user of the calling end may hear a busy tone or hangup prompt; if the user of the called end selects to answer the call, a conversation stage is entered. The third stage is the conversation stage: both the calling end and the called end can select to hang up, to end the conversation process.

In the foregoing conventional conversation process, in the response waiting stage, because it is inconvenient for the user of the called end to answer the call, or the user of the called end is unwilling to answer the call, or there is not enough time for the user of the called end to prepare for answering the call, the situation that the user of the called end neither answers the call nor hangs up may exist. In this situation, the following situations may generally exist. One situation is that: a call process lasts. In this case, the calling end wait for a long time, and the called end rings for a long time, which causes long-time occupation of communication resources, wastes time of the users of the calling end and of the called end, and brings disturbance to users of both parties. Another situation is that: the system ends the call process directly. In this case, the user of the calling end may hear the busy tone or hangup prompt. The user of the calling end cannot know an actual reason of a failure of the current call because the result of this solution is the same as that occurring when the user of the called end selects to hang up, thereby lowering the user experience. Another situation is that: the user of the calling end selects to hang up, gives up this call process, and initiates a new call process. Because a right of the user of the calling end is not restricted in the foregoing conversation process, the call can be performed on the called end infinitely, causing disturbance to the user of the called end.

Another problem is that the user of the called end may not be knowledgeable regarding whether a phone call should be answered. A cell phone may display the number of the cell phone that is calling, or the name of the user of the calling cell phone but does not contain other information. An associated problem would be that the users of both the calling end and the called end may have difficult time recalling the situation surrounding the call as the call log only displays the time and the identity of the other end of the phone call.

Yet another problem of the current technology is that a phone call creates certain urgency for the user of the called end to act. The user of the called end knows if he/she does not answer the call, he/she may have to arrange another time which may be difficult and uncertain. The urgency associated with a call may be undesirable for the user on the calling end as well. The user of the calling end may be afraid that he/she is not calling at the right time.

Yet another problem of the current technology is that a person may not know whether it is appropriate to call another person. The two people may be connected by an online instant messenger tool and never talk before. Current technology permits every user to call everyone else. However, a user may want to limit the relationship with another user to the scope of online messaging but not phone-call conversation. In order to enhance user experience, the developer of the online instant messenger tool may want to regulate the authorization of calling another user so as to prevent users from being disturbed by undesirable calls.

### SUMMARY

Embodiments of the present invention provide a conversation method and apparatus, and a terminal, which can implement a responsive conversation, so that not only can a user of a calling end know an actual reason of a call failure, but also long-time occupation of communication resources can be avoided, and a call right of the calling end is restricted, thereby avoiding call disturbance and improving intelligence of a conversation process.

In one aspect of the current invention, a method of conversation comprises, at a first mobile communication terminal having one or more processors and memory, receiving a conversation request from a second mobile communication terminal, wherein the conversation request contains a call invitation request that expires after a first time period; displaying the call invitation request; establishing a call connection with the second mobile communication terminal in response to detecting a first predefined user operation on the call invitation request within the first time period; replacing the display of the call invitation request with the display of the conversation request after the first time period, the conversation request further including a call initiation command that expires after a second time period; and initiating a call to the second mobile communication terminal if detecting a second predefined user operation on the call initiation command after the first time period and within the second time period, wherein the second time period is longer than the first time period. In one embodiment, the lengths of the first time period and the second time period are both set by the user of the second mobile communication terminal.

In another aspect of the current invention, a first mobile communication terminal, comprises one or more processors and memory for storing one or more program modules, wherein the one or more program modules, when executed by the one or more processors, cause the first mobile communication terminal to (1) receive a conversation request from a second mobile communication terminal, wherein the conversation request contains a call invitation request that expires after a first time period; (2) display the call invitation request; (3) establish a call connection with the second mobile communication terminal in response to detecting a first predefined user operation on the call invitation request within the first time period; (4) replace the display of the call invitation request with the display of the conversation request after the first time period, the conversation request further including a call initiation command that expires after a second time period; and (5) initiate a call to the second mobile communication terminal if detecting a second predefined user operation on the call initiation command after the first time period and within the second time period, wherein the second time period is longer than the first time period.

In yet another aspect of the current invention, a non-transitory computer readable storage medium storing one or more program modules configured for execution by a first mobile communication terminal that includes one or more processors, the one or more program modules including instructions for: (1) receiving a conversation request from a second mobile communication terminal, wherein the conversation request contains a call invitation request that expires after a first time period; (2) displaying the call invitation request; (3) establishing a call connection with the second mobile communication terminal in response to detecting a first predefined user operation on the call invitation request within the first time period; (4) replacing the display of the call invitation request with the display of the conversation request after the first time period, the conversation request further including a call initiation command that expires after a second time period; and (5) initiating a call to the second mobile communication terminal if detecting a second predefined user operation on the call initiation command after the first time period and within the second time period, wherein the second time period is longer than the first time period.

As one benefit of the current invention, when a cell phone user receives a conversation request, the user knows that he/she can answer the call or he/she can postpone the decision, knowing that he/she can easily call back in the second time period. When the second time period is set by the user of the calling end, the user of the called end could easily know that calling back within the second time period is acceptable to the user of the calling end.

When the conversation request is sent along with text, image, audio, or video information, the user of the calling end has an opportunity to provide a context for the call. In addition, the user of the called end may know the reason of the phone call. Also, the text, image, audio or video information also gives the user of both ends a record regarding the context of the phone call.

### BRIEF DESCRIPTION OF DRAWINGS

The aforementioned implementation of the invention as well as additional implementations will be more clearly understood as a result of the following detailed description of the various aspects of the invention when taken in conjunction with the drawings. Like reference numerals refer to corresponding parts throughout the several views of the drawings.

To describe the technical solutions in the embodiments of the present invention or in the prior art more clearly, the following briefly introduces the accompanying drawings required for describing the embodiments or the prior art. Apparently, the accompanying drawings in the following descriptions show merely some embodiments of the present invention, and persons of ordinary skill in the art may still derive other drawings from the accompanying drawings without creative efforts.

FIG. 1 is a flow chart of a conversation method according to an embodiment of the present invention;

FIG. 2 is a flow chart of another conversation method according to an embodiment of the present invention;

FIG. 3 is a flow chart of still another conversation method according to an embodiment of the present invention;

FIG. 4 is a flow chart of still another conversation method according to an embodiment of the present invention;

FIG. 5 is a schematic structural diagram of a conversation apparatus according to an embodiment of the present invention;

FIG. 6 is a schematic structural diagram of another conversation apparatus according to an embodiment of the present invention;

FIG. 7 is a schematic structural diagram of a right judgment module according to an embodiment of the present invention; and

FIG. 8 is a schematic structural diagram of still another conversation apparatus according to an embodiment of the present invention.

FIG. 9 is a flowchart illustrating a method of conversation according to an implementation of the current invention.

FIG. 10 is a structural block diagram of a terminal according to an embodiment of the current invention.

FIG. 11 is a structural block diagram of a request sending/receiving module of a terminal shown in FIG. 10.

FIG. 12 is a structural block diagram of a management module of a terminal shown in FIG. 10.

FIG. 13 is a flow chart of a terminal working with a conversation request according to an embodiment of the current invention.

### DETAILED DESCRIPTION

The technical solutions in the embodiments of the present invention are described clearly and completely in the following with reference to the accompanying drawings in the embodiments of the present invention. Apparently, the described embodiments are merely a part rather than all of the embodiments of the present invention. All other embodiments obtained by persons of ordinary skill in the art based on the embodiment of the present invention without creative efforts shall fall within the protection scope of the present invention.

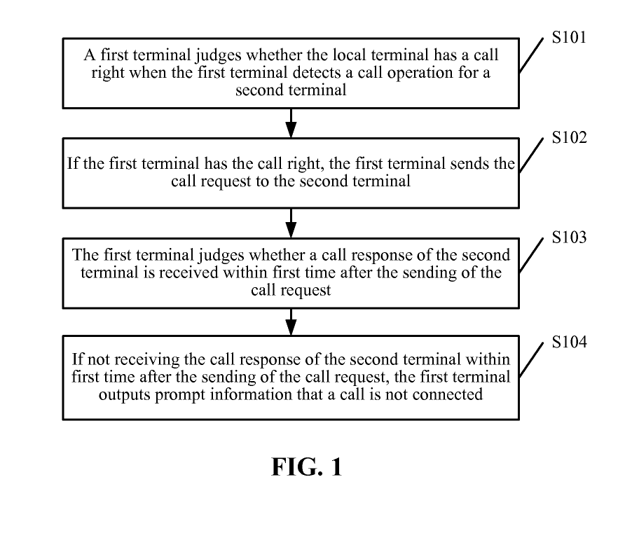

In the embodiments of the present invention, a terminal includes, but is not limited to, a device such as a Personal Computer (PC), a tablet computer, a phone, a smart phone, an electronic reader, and a notebook computer. A conversation apparatus may be an apparatus set in the terminal and capable of implementing a responsive conversation of the terminal. The conversation apparatus may be an apparatus such as instant messaging software and a contact conversation application, and may also be a functional module, which implements the responsive conversation, in the apparatus such as the instant messaging software and the contact conversation application. A conversation or a call between terminals may include a voice conversation in the contact conversation application and an audio conversation or a video conversation in the instant messaging application. A conversation or a call may also include an audio or video conference among more than two terminals. There are various ways that the first terminal and the second terminal are connected together. In one embodiment, they are connected through a mobile communication network. In another embodiment, they are connected by the internet. In yet another embodiment, the two terminals are both installed with an application and both connected with a server. Unless otherwise stated, in subsequent embodiments that shown in FIGS. 1-8, a first terminal may be a calling end initiating a call request, and a second terminal may be a called end receiving the call request.

A conversation method according to an embodiment of the present invention is described in detail in the following with reference to FIG. 1 to FIG. 4.

FIG. 1 is a flow chart of a conversation method according to an embodiment of the present invention. The method may include the following step S101 to step S104.

S101: A first terminal judges whether the local terminal has a call right when the first terminal detects a call operation for a second terminal.

A user of the first terminal may initiate the call operation for the second terminal. For example, the user of the first terminal may initiate the call operation for the second terminal by dialing a number of the second terminal; or the user of the first terminal may initiate the call operation for the second terminal by pressing a key, for initiating an audio and video chat, provided in the first terminal. In this step, when detecting the call operation for the second terminal initiated by the first terminal, the first terminal judges whether the local terminal has the call right. If the first terminal has the call right, it indicates that the first terminal can respond to the call operation of the user, and initiate the call request to the second terminal to request a conversation with the second terminal; if the first terminal does not have the call right, it indicates that the first terminal cannot respond to the call operation of the user, and cannot initiate the call request to the second terminal to request a conversation with the second terminal.

S102: If the first terminal has the call right, the first terminal sends the call request to the second terminal.

Before initiating the call request to the second terminal, the first terminal judges the call right of the first terminal, and initiates the call request to the second terminal only when the first terminal has the call right, which can avoid call disturbance to the called second terminal, and can improve intelligence of a conversation process.

S103: The first terminal judges whether a call response of the second terminal is received within first time after the sending of the call request.

The first time may be set according to actual requirements. For example, the first time may be set reasonably according to a current load condition of the network, so as to reduce occupied communication resources in a call process; or the first time may be set according to a type of a system of the terminal. A time delay of the call request exists in a system of some terminal and the user of the called second terminal cannot be informed of the call request in time, so a value of the first time may be set to being equal to or greater than the time delay, thereby ensuring that the second terminal outputs the call request in real time, and increasing the call completion rate. The call response of the second terminal includes: an answering response or a rejection (hangup) response. In this step, the first time may be preferably set to 10 minutes. The first terminal judges whether the answering response or rejection (hangup) response of the second terminal is received within 10 minutes after sending the call request. If the answering response of the second terminal is received, the first terminal and the second terminal enter a conversation stage. If the rejection (hangup) response of the second terminal is received, the call of the first terminal fails, and the conversation process between the first terminal and the second terminal ends. If neither the answering response of the second terminal nor the rejection (hangup) response of the second terminal is received, the procedure turns to step S104.

S104: If not receiving the call response of the second terminal within first time after the sending of the call request, the first terminal outputs prompt information that a call is not connected.

The prompt information that a call is not connected is used for reminding the user of the first terminal that the called second terminal does not make any call response in the current call process. The prompt information that a call is not connected can be output in various manners, such as a voice manner, a short message manner or a picture manner.

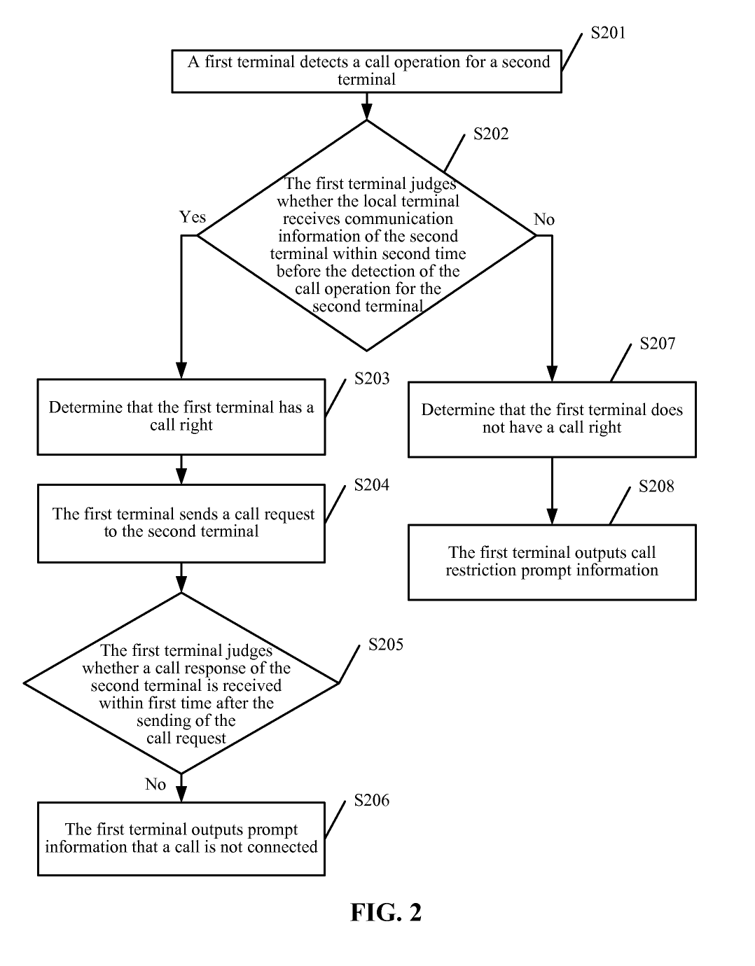

FIG. 2 is a flow chart of another conversation method according to an embodiment of the present invention. The method may include the following step S201 to step S208.

S201: A first terminal detects a call operation for a second terminal.

In this step, a user of the first terminal may initiate the call operation for the second terminal. For example, the user of the first terminal may initiate the call operation for the second terminal by dialing a number of the second terminal; or the user of the first terminal may initiate the call operation for the second terminal by pressing a key, for initiating an audio and video chat, provided in the first terminal.

S202: The first terminal judges whether the local terminal receives communication information of the second terminal within second time before the detection of the call operation for the second terminal; if a judgment result is yes, the procedure turns to step S203; otherwise, the procedure turns to step S207.

The communication information includes, but is not limited to, text information, picture information, voice information, video information, expression information or card information. The second time may be set according to actual requirements. For example, the second time may be set by gathering a statistic of a Do-Not-Disturb time value acceptable by the user. For example, in this step, the second time is preferably set to 10 minutes, and the first terminal judges whether the local terminal receives the communication information of the second terminal within 10 minutes before detecting the call operation for the second terminal.

S203: Determine that the first terminal has a call right.

If the first terminal already receives the communication information of the second terminal within the second time before initiation of a call request to the second terminal, it is indicated that the call request to be initiated by the first terminal does not cause call disturbance to the user of the second terminal, and the first terminal has the call right.

S204: The first terminal sends a call request to the second terminal.

S205: The first terminal judges whether a call response of the second terminal is received within first time after the sending of the call request; if a judgment result is no, the procedure turns to step S206.

S206: If not receiving the call response of the second terminal within the first time after the sending of the call request, the first terminal outputs prompt information that a call is not connected, and then the procedure ends.

In this embodiment, for step S204 to step S206, reference may be made to step S102 to step S104 of the embodiment shown in FIG. 1. It should be noted that, the prompt information that a call is not connected can be stored and output according to a specific rule. For example, according to a time sequence rule, the prompt information that a call is not connected is sequenced according to time, and is stored and output in sequence; for another example, according to a collection rule, the prompt information that a call is not connected of the same calling end is collected, and collected content is stored and output; for yet another example, according to a combination rule of time sequence and collection, the prompt information that a call is not connected of the same calling end is collected, and the collected content is stored and output after being sequenced according to time. The prompt information that a call is not connected may be stored and output by being independent of the communication information, and may also be stored and output in combination with the communication information.

S207: Determine that the first terminal does not have a call right.

If the first terminal does not receive the communication information of the second terminal within the second time before initiation of a call request to the second terminal, it is indicated that the call request to be initiated by the first terminal may cause call disturbance to the user of the second terminal, and the first terminal does not have the call right.

S208: The first terminal outputs call restriction prompt information.

In this step, the call restriction prompt information may be considered to be Do-Not-Disturb prompt information. For example, the first terminal may output call restriction prompt information “Do-Not-Disturb prompt: because the opposite side did not send communication information to you within 10 minutes, the conversation cannot be initiated temporarily, and you are advised to send communication information to the opposite side for contact.”. The call restriction prompt information is used for reminding the user of the first terminal that the current call may cause disturbance to the user of the second terminal, and may further prompt the user of the first terminal to obtain the call right before making a call.

Through description of the foregoing embodiment, a responsive conversation is adopted in the present invention. When a call response of a called end (that is, a second terminal) is not received within certain time, prompt information that a call is not connected is output in a calling end (that is, a first terminal), which can enable a user of the calling end to know an actual reason of a call failure, avoid long-time occupation of communication resources, and save the time of both parties of the conversation. In addition, in the embodiment of the present invention, before the calling end initiates a call request, a call right of the calling end is verified, thereby preventing call disturbance to the called end, and improving intelligence of a conversation process.

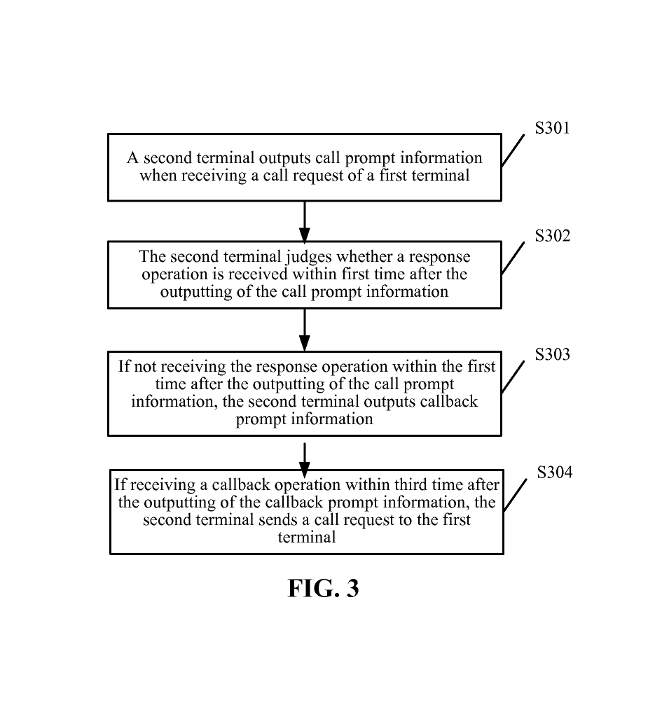

FIG. 3 is a flow chart of still another conversation method according to an embodiment of the present invention. The method may include the following step S301 to step S304.

S301: A second terminal outputs call prompt information when receiving a call request of a first terminal.

The call prompt information may be output in various manners, for example, a ringing manner or a short message manner. The call prompt information is used for reminding a user of the second terminal that the call request initiated by a user of the first terminal is received currently, and prompting the user of the second terminal to select answering or rejection (hangup).

S302: The second terminal judges whether a response operation is received within first time after the outputting of the call prompt information.

The response operation refers to an operation performed by the user of the second terminal for the call request of the first terminal, and includes an answering operation and a rejection (hangup) operation. The first time may be set according to actual requirements. For example, the first time may be set reasonably according to a current load condition of the network, so as to reduce occupied communication resources in a call process; or the first time may be set according to a type of a system of the terminal. A time delay of the call request exists in a system of some terminal and the user of the called second terminal cannot be informed of the call request in time, so a value of the first time may be set to being equal to or greater than the time delay, thereby ensuring that the second terminal outputs the call request in real time, and increasing the call completion rate.

In specific implementation, when outputting the call prompt information, the second terminal may provide response operation keys. If the user presses an answering operation key, it indicates that the user of the second terminal accepts the call request of the first terminal, and the second terminal establishes the conversation connection with the first terminal, to enter a conversation stage; if the user presses a rejection (hangup) key, it indicates that the user of the second terminal rejects the call request of the first terminal, the second terminal breaks a conversation connection with the first terminal, and the call of the first terminal fails. In this step, the first time is preferably set to 10 minutes. The second terminal judges whether the response operation of the user is received within 10 minutes after outputting the call prompt information. If neither the answering operation of the second terminal nor the rejection (hangup) operation of the second terminal is received, the procedure turns to step S303.

S303: If not receiving the response operation within the first time after the outputting of the call prompt information, the second terminal outputs callback prompt information.

The callback prompt information is used for reminding the user of the second terminal that the conversation connection can be established with the first terminal through a callback operation. Preferably, the callback prompt information includes a callback link, and when the user of the second terminal clicks the callback prompt information, the callback operation can be initiated. The callback prompt information can be output in various manners, such as, a voice manner, a short message manner or a picture manner.

S304: If receiving a callback operation within third time after the outputting of the callback prompt information, the second terminal sends a call request to the first terminal.

The third time characterizes valid time during which the user of the second terminal can perform the callback operation and initiate the callback call request to the first terminal. For the setting of the third time, reference may be made to the process of setting the first time. In this step, the third time may preferably be 10 minutes. If receiving the callback operation within 10 minutes after outputting the callback prompt information, the second terminal sends the call request to the first terminal. It should be noted that, after receiving the call request of the second terminal, the first terminal can adopt the processing manner which is the same as that of the second terminal in this embodiment for processing.

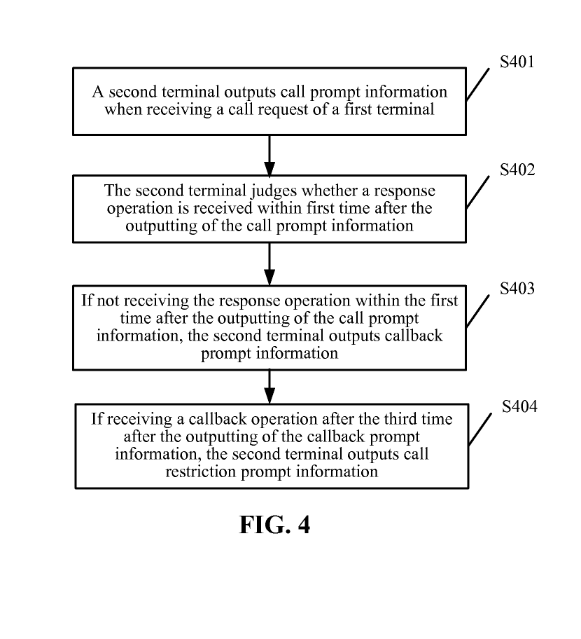

FIG. 4 is a flow chart of still another conversation method according to an embodiment of the present invention. The method may include the following step S401 to step S404.

S401: A second terminal outputs call prompt information when receiving a call request of a first terminal.

S402: The second terminal judges whether a response operation is received within first time after the outputting of the call prompt information.

S403: If not receiving the response operation within the first time after the outputting of the call prompt information, the second terminal outputs callback prompt information.

In this embodiment, for step S401 to step S403, reference may be made to step S301 to step S303 of the embodiment shown in FIG. 3, which will not be described herein again.

S404: If receiving a callback operation after the third time after the outputting of the callback prompt information, the second terminal outputs call restriction prompt information.

In this step, the third time may preferably be 10 minutes. If receiving the callback operation after 10 minutes after outputting the callback prompt information, the second terminal outputs the call restriction prompt information. The call restriction prompt information may be considered to be Do-Not-Disturb prompt information. For example, the second terminal may output the call restriction prompt information “Do-Not-Disturb prompt: because the opposite side did not send communication information to you within 10 minutes, the conversation cannot be initiated temporarily, and you are advised to send communication information to the opposite side for contact.”. The call restriction prompt information is used for reminding a user of the second terminal that a valid callback time is exceeded and that the current call may cause disturbance to a user of the first terminal, and may further prompt the user of the second terminal to obtain a call right before making a call.

Through description of the embodiment, in a responsive conversation process of the present invention, when a user of a called end does not perform a response operation for a call request of a calling end within certain time, callback prompt information is output in the called end, and a communication connection between the calling end and the called end is established in a callback manner, thereby relieving an answering pressure of the user of the called end, providing more sufficient time for establishing a conversation process, saving waiting time of both parties of a conversation, and improving communication efficiency.

The foregoing conversation method is described in detail in the following through an example of interaction between a first terminal and a second terminal.

It is assumed that the first terminal is terminal A and the second terminal is terminal B. User A is using instant messaging software of terminal A, and user B is using instant messaging software of terminal B. It is assumed that first time, second time and third time are all 10 minutes. When user A presses a key, for initiating a video chat, provided by the instant messaging software of terminal A, to initiate a call operation for user B, the flow of the conversation method of the present invention is as follows:

Terminal A detects the call operation of user A, and judges whether communication information is received from terminal B within 10 minutes; if the communication information of terminal B is not received within 10 minutes, terminal A displays call restriction information prompt information to user A: “Do-Not-Disturb prompt: because the opposite side did not send communication information to you within 10 minutes, the conversation cannot be initiated temporarily, and you are advised to send communication information to the opposite side for contact.”; if the communication information of terminal B is already received within 10 minutes, terminal A sends a call request to terminal B, to request establishing a conversation with terminal B.

After receiving the call request of terminal A, terminal B may output call prompt information in a short message manner: “user A is initiating a video chat request, select answering or rejection (hangup).” If user B selects answering within 10 minutes after outputting the call prompt information, terminal B sends an answering response to terminal A, and terminal A and terminal B enter a conversation stage; and if user B selects rejection (hangup) within 10 minutes after outputting the call prompt information, terminal B sends a rejection response to terminal A, terminal B breaks a conversation connection with terminal A, and the call of terminal A fails. If user B neither selects answering nor rejection (hangup) within 10 minutes after outputting the call prompt information, terminal B displays callback prompt information on an information interface of the instant messaging software of terminal B. At the same time, terminal A displays prompt information that a call is not connected on an information interface of the instant messaging software of terminal A.

If user B clicks the callback prompt information on the information interface of the instant messaging software of terminal B to initiate a callback operation within 10 minutes after outputting the callback prompt information, terminal B sends a call request to terminal A. After receiving the call request of terminal B, terminal A adopts the processing manner which is the same as that of terminal B for processing. If user B clicks the callback prompt information on the information interface of the instant messaging software of terminal B to initiate the callback operation after 10 minutes after outputting the callback prompt information, terminal B displays call restriction prompt information to user B: “Do-Not-Disturb prompt: because the opposite side did not send communication information to you within 10 minutes, the conversation cannot be initiated temporarily, and you are advised to send communication information to the opposite side for contact.”.

In the embodiment of the present invention, a responsive conversation is adopted. When a call response of a called end (that is, a second terminal) is not received within certain time, prompt information that a call is not connected is output in a calling end (that is, a first terminal), which can enable a user of the calling end to know an actual reason of a call failure, avoid long-time occupation of communication resources, and save the time of both parties of the conversation. In addition, in the embodiment of the present invention, before the calling end initiates a call request, a call right of the calling end is verified, thereby preventing call disturbance to the called end, and improving intelligence of a conversation process. Moreover, in the responsive conversation process of the embodiment of the present invention, when a user of a called end does not perform a response operation for a call request of a calling end within certain time, callback prompt information is output in the called end, and a communication connection between the calling end and the called end is established in a callback manner, thereby relieving an answering pressure of the user of the called end, providing more sufficient time for establishing a conversation process, saving waiting time of both parties of a conversation, and improving communication efficiency.

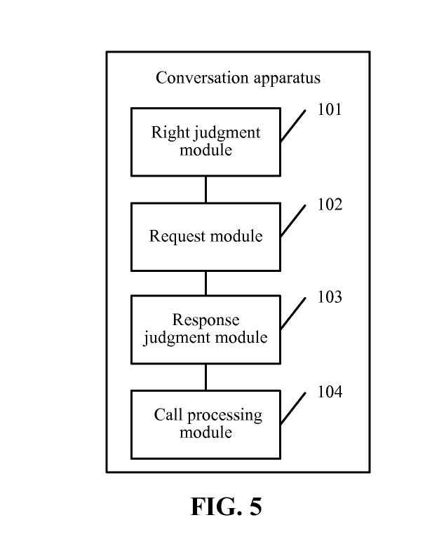

A conversation apparatus according to an embodiment of the present invention is described in detail in the following with reference to FIG. 5 to FIG. 8. It should be noted that the following apparatus may be applied in the foregoing method embodiment to perform the conversation method.

FIG. 5 is a schematic structural diagram of a conversation apparatus according to an embodiment of the present invention. In this embodiment, the conversation apparatus is set in a first terminal to implement a responsive conversation with a second terminal. The apparatus may include: a right judgment module 101, a request module 102, a response judgment module 103, and a call processing module 104.

The right judgment module 101 is configured to judge whether a first terminal has a call right when the first terminal detects a call operation for a second terminal.

If the first terminal has the call right, it indicates that the first terminal can respond to a call operation of a user, and initiate the call request to the second terminal to request a conversation with the second terminal; if the first terminal does not have the call right, it indicates that the first terminal cannot respond to the call operation of the user, and cannot initiate the call request to the second terminal to request a conversation with the second terminal.

The request module 102 is configured to send the call request to the second terminal when the first terminal has the call right.

Before initiating the call request to the second terminal, the first terminal judges the call right of the first terminal, and initiates the call request to the second terminal only when the first terminal has the call right, which can avoid call disturbance to the called second terminal, and can improve intelligence of a conversation process.

The response judgment module 103 is configured to judge whether a call response of the second terminal is received within first time after the sending of the call request.

If an answering response of the second terminal is received within the first time after the sending of the call request, the first terminal and the second terminal enter a conversation stage. If a rejection (hangup) response of the second terminal is received within the first time after the sending of the call request, a call of the first terminal fails, and a conversation process between the first terminal and the second terminal ends. If neither the answering response of the second terminal nor the rejection (hangup) response of the second terminal is received within the first time after the sending of the call request, the call processing module 104 is notified of performing processing.

The call processing module 104 is configured to, when the call response of the second terminal is not received within the first time after the sending of the call request, output prompt information that a call is not connected.

The prompt information that a call is not connected is used for reminding a user of the first terminal that the called second terminal does not make any call response in the current call process. The prompt information that a call is not connected can be output in various manners, such as a voice manner, a short message manner or a picture manner.

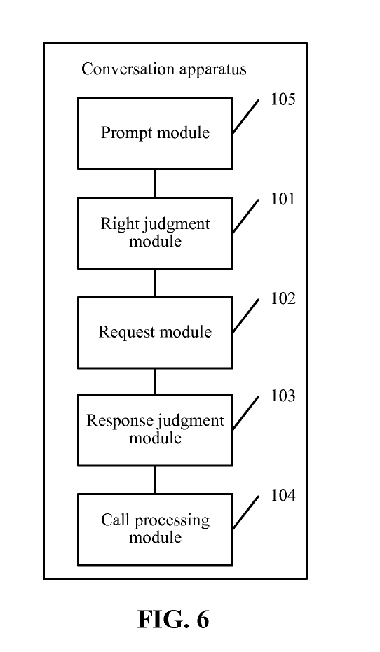

FIG. 6 is a schematic structural diagram of another conversation apparatus according to an embodiment of the present invention. In this embodiment, the conversation apparatus is set in a first terminal to implement a responsive conversation with a second terminal. The apparatus may include: a right judgment module 101, a request module 102, a response judgment module 103, a call processing module 104 and a prompt module 105. For the structures of the right judgment module 101, the request module 102, the response judgment module 103 and the call processing module 104, reference may be made to related description of the embodiment shown in FIG. 5, which will not be described herein again.

The prompt module 105 is configured to output call restriction prompt information when the first terminal does not have the call right.

The call restriction prompt information may be considered to be Do-Not-Disturb prompt information. For example, the first terminal may output the call restriction prompt information “Do-Not-Disturb prompt: because the opposite side did not send communication information to you within 10 minutes, the conversation cannot be initiated temporarily, and you are advised to send communication information to the opposite side for contact.”. The call restriction prompt information is used for reminding a user of the first terminal that the current call may cause disturbance to a user of the second terminal, and may further prompt the user of the first terminal to obtain the call right before making a call.

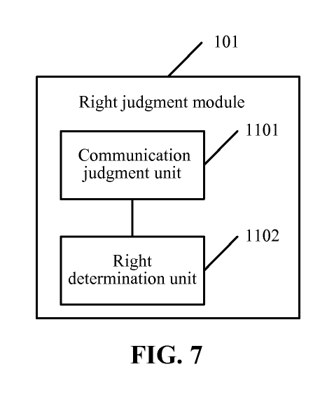

FIG. 7 is a schematic structural diagram of a right judgment module according to an embodiment of the present invention. The right judgment module 101 may include: a communication judgment unit 1101 and a right determination unit 1102.

The communication judgment unit 1101 is configured to judge whether the first terminal receives communication information of the second terminal within second time before the detection of the call operation for the second terminal.

The right determination unit 1102 is configured to: when the first terminal receives the communication information of the second terminal within the second time before the detection of the call operation for the second terminal, determine that the first terminal has the call right; or when the first terminal does not receive the communication information of the second terminal within the second time before the detection of the call operation for the second terminal, determine that the first terminal does not have the call right.

Through description of the foregoing embodiment, a responsive conversation is adopted in the present invention. When a call response of a called end (that is, a second terminal) is not received within certain time, prompt information that a call is not connected is output in a calling end (that is, a first terminal), which can enable a user of the calling end to know an actual reason of a call failure, avoid long-time occupation of communication resources, and save the time of both parties of the conversation. In addition, in the embodiment of the present invention, before the calling end initiates a call request, a call right of the calling end is verified, thereby preventing call disturbance to the called end, and improving intelligence of a conversation process.

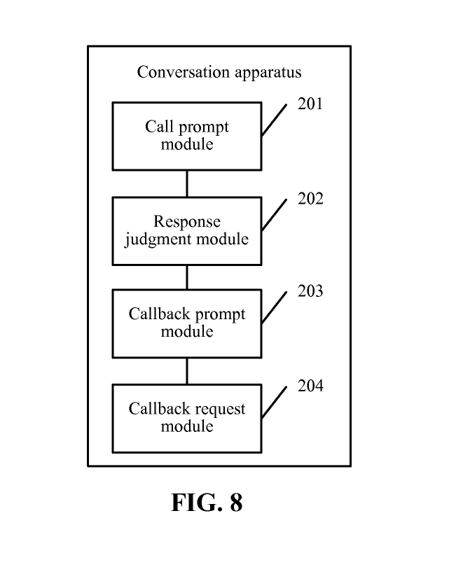

FIG. 8 is a schematic structural diagram of still another conversation apparatus according to an embodiment of the present invention. In this embodiment, the conversation apparatus is set in a second terminal to implement a responsive conversation with a first terminal. The apparatus may include: a call prompt module 201, a response judgment module 202, a callback prompt module 203 and a callback request module 204.

The call prompt module 201 is configured to output call prompt information when a second terminal receives a call request of a first terminal.

The response judgment module 202 is configured to judge whether the second terminal receives a response operation within first time after the outputting of the call prompt information.

The callback prompt module 203 is configured to: when the second terminal does not receive the response operation within the first time after the outputting of the call prompt information, output callback prompt information.

The callback prompt module 203 is further configured to: when the second terminal receives the callback operation after third time after the outputting of the callback prompt information, output call restriction prompt information.

The callback request module 204 is configured to: when the second terminal receives a callback operation within the third time after the outputting of the callback prompt information, send a call request to the first terminal.

Through description of the foregoing embodiment, in a responsive conversation process of the present invention, when a user of a called end does not perform a response operation for a call request of a calling end within certain time, callback prompt information is output in the called end, and a communication connection between the calling end and the called end is established in a callback manner, thereby relieving an answering pressure of the user of the called end, providing more sufficient time for establishing a conversation process, saving waiting time of both parties of a conversation, and improving communication efficiency.

A terminal is further disclosed in an embodiment of the present invention. The terminal may include the conversation apparatus of any one of the embodiments shown in FIG. 5 to FIG. 7. For the structure of the conversation apparatus, reference may be made to the related description of the embodiments shown in FIG. 5 to FIG. 7, which will not be described herein again. It should be noted that, the terminal may be applied in the methods of the embodiments shown in FIG. 1 to FIG. 4.

Another terminal is further disclosed in an embodiment of the present invention. The terminal may include the conversation apparatus shown in FIG. 8. For the structure of the conversation apparatus, reference may be made to the related description of the embodiments shown in FIG. 5 to FIG. 7, which will not be described herein again. It should be noted that, the terminal may be applied in the methods of the embodiments shown in FIG. 1 to FIG. 4.

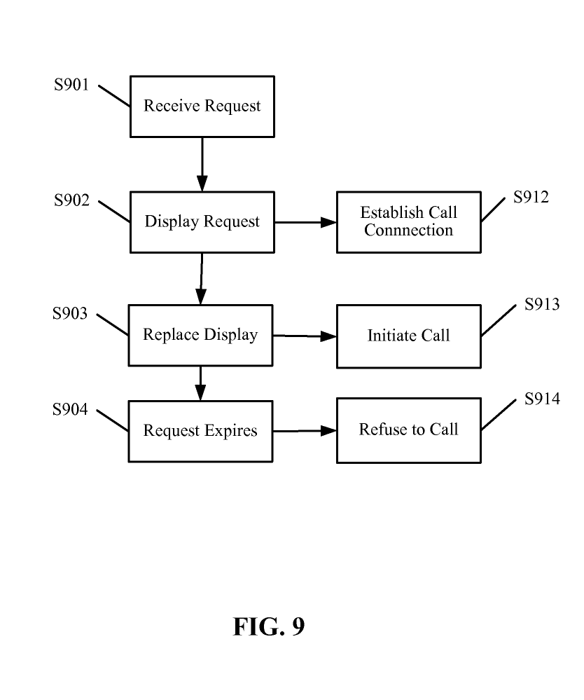

FIG. 9 is a flowchart of a method of conversation according to another embodiment of the current invention. In step S901, a first terminal receives a conversation request from a second terminal. The conversation request can be received either through wireless or wired network or a combination of both.

In step S902, the first terminal displays the conversation request. There are many ways of displaying the conversation request. In one embodiment, the conversation request has an icon and a message from the second terminal displayed together. The message may include text, image, audio or video information that is created by the user of the second terminal. One example is that the first terminal displays a sentence: “let's plan for our Hawaii trip” and the sentence is displayed with an image of “sailing” and an icon like a telephone. The icon represents a call invitation request. In another embodiment, the text, image, audio or video information is sent from two or more different mobile communication terminals.

The call invitation request is set to expire after the first time period. In one embodiment, the user of the second terminal keeps the call invitation request alive until he/she releases the call invitation request. In another embodiment, the user of the second terminal can set the length of the first time period before sending out the conversation request. If the user of the first terminal decides to answer the call, he/she can give an instruction to the first terminal by performing a predefined user operation. A predefined user operation of answering the call could be clicking an icon that is displayed as part of the call request. Another predefined user operation of answering the call could be the user speaking to the terminal. For example, the user may say “answer” to the terminal to instruct the terminal to answer the call invitation request.

If the first terminal detects the predefined user operation of answering the call invitation request within the first time period, the first terminal performs step S912 by establishing a conversation connection with the second terminal. The user of the first terminal and the user of the second terminal can then speak with each other.

However, if the user of the first terminal chooses not to answer the call, the call invitation request expires after the first time period. In step S903, the display of the call invitation request is replaced with the display of the conversation request after the first time period. This conversation request further includes a call initiation command that is set to expire after a second time period. In one embodiment, the call initiation command is displayed entirely different from the call invitation request or not displayed at all. In another embodiment, the call initiation command is displayed in a same or similar manner as the call invitation request. For example, the call invitation request may be displayed as a dynamic icon that is shaking or jumping on the display and the call initiation command is displayed as a static icon. Alternatively, the call invitation request may be displayed as a red icon and the call initiation command is displayed as a blue icon. In one embodiment, the length of the second time period is set by the user of the second terminal. For example, a user may have a meeting three hours after sending the conversation request and set the second time period to start from sending the conversation request to 2 hours and 50 minutes later. In another example, a user may have an urgent task to handle and prefers to work for the next 2 hours uninterrupted. In this case, the user may set the second time period to start from 2 hours from now and then last for a hour. In one embodiment, the length of the second time period is longer than the length of the first time period, which might last for less than a few minutes.

In step S913, if the first terminal detects a second predefined user operation on the call initiation command, the first terminal initiates a call to the second terminal. The second predefined user operation could be clicking an icon, speaking to the terminal, a certain gesture in front of the terminal, an operation on another terminal that is connected with the first terminal, or any other user-machine interaction method. In one embodiment, the second predefined user operation is the same as the first predefined user operation. The first terminal differentiates between the first predefined user operation and the second predefined user operation by the time of the operation. For example, the first and second predefined user operation may be clicking the same icon. If the user clicks the icon within the first time period, the first terminal detects the first user operation and answers the call. If the user clicks the icon after the first time period and within the second time period, the first terminal detects the second user operation and initiates a call to the second terminal.

In step S904, the call initiation command is set to expire after the second time period. In one embodiment, after the call initiation command expires, in step S914, the first terminal refuses to initiate a call to the second mobile communication terminal in response to detecting a predefined user operation on the call initiation command. For example, if the user of the second terminal sets the second time period to expire at 3 pm, the first terminal could refuse to initiate the call and display a message “Conversation request has expired” when the user of the first terminal clicks the icon on 4 pm. There are various ways of showing that the call initiation command has expired, e.g., by the disappearance of the icon, by showing a message, by generating a sound, by changing the color of the icon, etc.

Also, in one embodiment, the conversation request does not contain a call invitation request. For example, the user of the second terminal may choose not to talk with the user of the first terminal right away or after the first time period. In this case, the user of the second terminal sends a conversation request that does not contain a call invitation request. The user of the second terminal may set the second time period to be from 8 am to 5 pm the next day and then send the conversation request to the user of the first terminal. In this embodiment, there is not step S912 at the first terminal.

In another embodiment, a conversation request can be sent from one terminal to multiple terminals. Any of the multiple terminals can accept the call invitation request during a first time period to join a conference call associated with the conversation request. After the first time period expires, any of the multiple terminals that receive the conversation request can initiate or join a conference call by performing a predefined operation on a call initiation command within a second time period. For every terminal that receives the conversation request, the process of receiving and accepting a conversation request is the same as in the embodiments shown in FIG. 9, except that the conversation request is for a multi-party conference call rather than a two-party call.

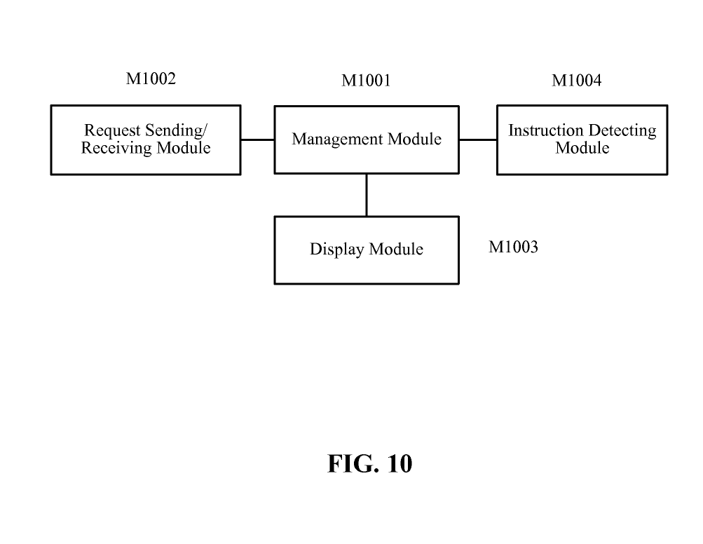

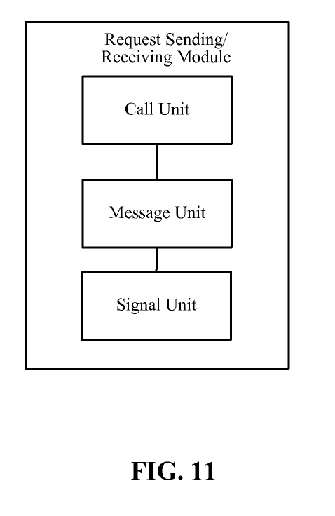

FIG. 10 is a schematic structural diagram of a terminal according to an embodiment of the present invention. The terminal includes one or more processors for executing modules, programs and/or instructions stored in memory and thereby performing predefined operations; one or more network or other communications interfaces; and one or more communication buses for interconnecting these components. In some implementations, the terminal includes a user interface comprising a display device and one or more input devices (e.g., keyboard or mouse). In some implementations, the memory includes high-speed random access memory, such as DRAM, SRAM, or other random access solid state memory devices. In some implementations, memory includes non-volatile memory, such as one or more magnetic disk storage devices, optical disk storage devices, flash memory devices, or other non-volatile solid state storage devices. Memory, or alternately one or more storage devices (e.g., one or more nonvolatile storage devices) within memory, includes a non-transitory computer readable storage medium. In some implementations, memory or the computer readable storage medium of memory stores a management module M1001, a request sending/receiving module M1002, a displaying module M1003 and an instruction detecting module M1004. For the structures of the request sending/receiving module and the management module 1001, references are made to the description related to the embodiment shown in FIGS. 10 and 11.

The request sending/receiving module M1002 is configured to receive a conversation request from a second terminal and to send a conversation request to the second terminal. In one embodiment, the conversation request contains a call invitation request that expires after a first time period.

The management module M1001 is configured to interpret the instructions from the request sending/receiving module M1002 according to the information contained in the conversation request and in the memory, especially the information regarding the first time period and a second time period associated with a call initiation command. After the first time period, the management module M1001 terminates the call invitation request and starts a call initiation request in the request sending/receiving module M1002. In one embodiment, the management module M1001 terminates the call initiation request after the second time period, in the request sending/receiving module M1002.

The displaying module M1003 is configured to display the conversation request as controlled by the management module M1001. In one embodiment, the conversation request is displayed along with the text, image, audio or video information. The text, image, audio or video information can be sent along with the conversation request from the second terminal. Alternatively, it may be sent from two or more different mobile communication terminals including the second terminal. There are different ways in which the display of a conversation request is varied after predefined events, including the expiration of a first time period, the expiration of a second time period, the answering of the call, the initiation of a call back to the second terminal, etc. After the call invitation request expires, the displaying module M1003 replaces the call invitation request with the display of the conversation request, the conversation request further including a call initiation command that expires after a second time period.

The instruction detecting module M1004 is configured to receive instructions from a user, including a first predefined user operation on the call invitation request and a second predefined user operation on the call initiation command. The first predefined user operation and the second predefined user operation can include various user input operations. Typical user input operations include, but are not limited to, touching a screen, pressing a keypad/keyboard, hand gestures in front of a device, relative movement between the terminal and the body, controlling signals from another device, etc. When the instruction detecting module M1004 detects a predefined user operation, it translates the user operation into a predefined user instruction and sends the categorization to the management module M1001.

The management module M1001's response to the instruction from the instruction detecting module M1004 depends both on the user instruction itself and other information, including timing information. In one embodiment, within the first time period, when the management module M1001 receives a user instruction interpreted as “answer the call”, the management module M1001 sends a signal to the request sending/receiving module M1002 and the request sending/receiving module M1002 then directs the terminal to answer the call invitation request by establishing a call connection with the second terminal. As a result, the user of the first terminal and the user of the second terminal are able to talk through the established call connection.

After the first time period expires but within the second time period, when the management module M1001 receives a user instruction interpreted as “call back”, the management module M1001 sends a signal to the request sending/receiving module M1002 and the request sending/receiving module M1002 then directs the terminal to initiate a call to the second terminal. In one embodiment, when the management module M1001 receives a user instruction of “answer the call” or “call back” after the second time period, the management module M1001 refuses to call the second terminal. The management module M1001 may further instruct the displaying module M1003 to display a message indicating that the second time period has expired when it receives “answer the call” or “call back” instruction. The displaying module M1003 may instruct the terminal to display the message showing that “the time to call back has expired.”

The conversation request will be automatically saved in the memory of the second terminal. Preferably, the conversation request is saved along with the events associated with the conversation request. For example, the conversation request is displayed in such way indicating that the call invitation request has been answered, that the first terminal has called back, that the conversation request has expired without an answer or that the first terminal has sent a message to the second terminal.

Importantly, in one embodiment, the user instruction for “answer the call” and “call back” may be interpreted as the same instruction. For example, when the first predefined user operation is the same as the second user operation, the instruction detecting module M1004 sends a broadly defined instruction to the management module M1001. In another example, the instruction detecting module M1004 sends a “call” instruction to the management module M1001, the management module M1001 then interprets the instruction according to other information. For example, before the call invitation request expires, the management module M1001 interprets the “call” instruction as answering the call. After the call invitation request expires and before call initiation command expiring, the management module M1001 interprets the “call” instruction as calling the second terminal.

FIG. 11 is a schematic structural diagram of an embodiment of a request sending/receiving module M1002 shown in FIG. 10. In this embodiment, the request sending/receiving module M1002 comprises a calling unit, a messaging unit and a signaling unit. The calling unit is configured to process an incoming call invitation request, to establish a call connection with the calling terminal and to send a call invitation request to another terminal.

The messaging unit is configured to receive and send text, image, audio, video information that is sent along with the call invitation request. When receiving a message that contains text, image, audio or video information, the messaging unit transmits the message to the displaying module. When a user inputs a conversation request that contains a message to the first terminal, the instruction detecting module M1004 receives a series of instructions and inputs that are relative to the message. The instruction detecting module M1004 then interprets the instructions and inputs, and provides the message to the messaging unit. The messaging unit then sends it as a part of a conversation request.

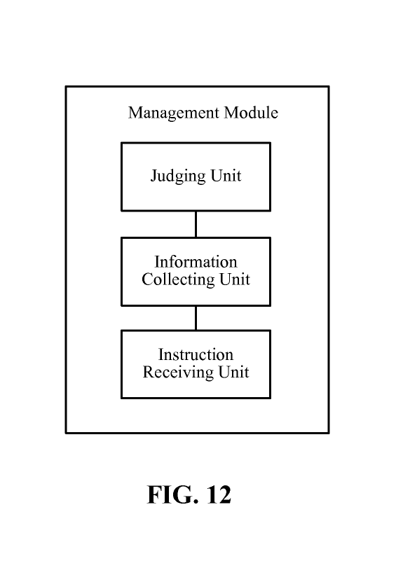

FIG. 12 is a schematic structural diagram of an embodiment of a management module shown in FIG. 10. In this embodiment, the management module comprises a judging unit, an instruction receiving unit and an information collecting unit. The instruction receiving unit is configured to receive user instructions from the instruction detecting module. The information collecting unit is configured to receive various information from the request sending/receiving module, including information regarding the first time period and the second time period. The judging unit is configured to make judgments based on the input from the instruction receiving unit and the information collecting unit and to send instructions to the request sending/receiving module and displaying module. For example, in one embodiment, when the instruction receiving unit receives an instruction of calling the second terminal and the information collecting unit provides a response that the second time period has not expired, the judging unit decides to instruct the request sending/receiving module to call the second terminal. In another embodiment, when the instruction receiving unit does not receive any instruction and the information collecting unit shows that the second time period has expired, the judging unit instructs the displaying module to display a message showing the expiration of the second time period.

The signaling unit is configured to receive and to send control information related with the conversation request. Control information related with the conversation request includes, but is not limited to, the first and the second time period and certain information that is necessary for the first terminal to start a call initiation command. For example, if the second terminal requires that a phone call be associated with a certain code, control information relation with the conversation request includes the code in addition to the identity/number of the second terminal. In another example, control information includes certain authorization from the second terminal to the first terminal to initiate a call back.

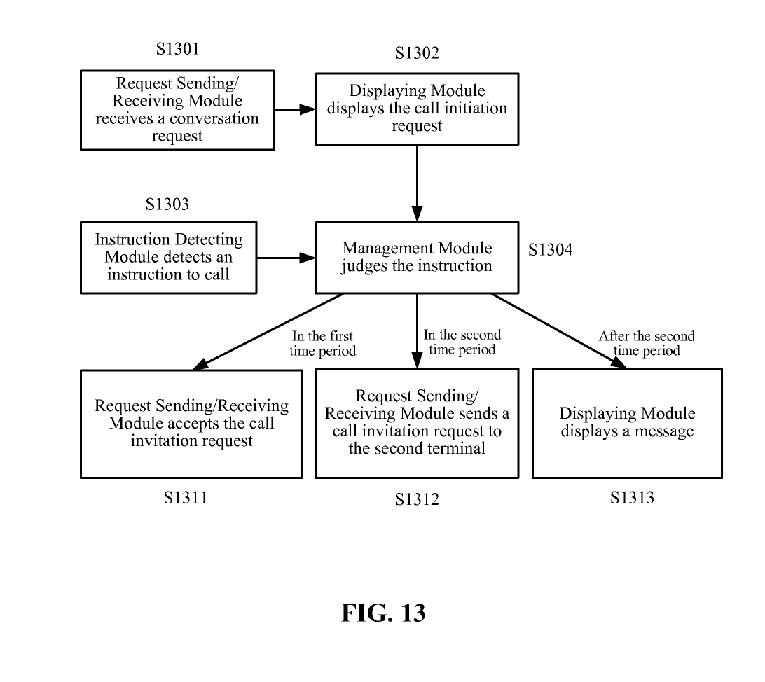

FIG. 13 is a flow chart illustrating the process of a terminal according to an embodiment illustrated in FIG. 10 for receiving and processing a conversation request.

When a first terminal receives a conversation request at step S1301, the request sending/receiving module processes the conversation request and sends it to the displaying module and the management module. The conversation request often contains a call invitation request that is set to expire after a first time period and information related with a second time period.

The displaying module then instructs the first terminal to alert the user of the arrival of the conversation request at step S1302. There are various ways of announcing the arrival of a conversation request, including vibrating the first terminal, emitting a light signal, producing a sound, or showing a message in a screen. When the conversation request is received with text, image, audio, or video information, the call invitation request may be displayed along with the text, image, audio, or video information. In one embodiment, the text, image, audio, or video information is sent from the second mobile communication terminal. In another embodiment, the text, image, audio, or video information is sent from two or more different mobile communication terminals including the second mobile communication terminal.

When a user sees or hears the conversation request, he/she can choose a predefined user operation in response to the conversation request. The instruction detecting module then detects a predefined user operation and interprets it into a predefined instruction at step S1303. The instruction detecting module transmits the predefined instruction to the management module, which judges the instruction based on the received predefined instruction and other information of the conversation request at step S1304.

During the first time period, the call invitation request is still alive and the user can choose to perform a predefined operation on the call invitation request. The management module receives the instruction from the user, detects that the call invitation request has not expired, and determines that it is a valid instruction to accept the call invitation request at step S1304. The request sending/receiving module then receives an instruction from the management module to make the first terminal to accept the invitation request in step S1311. In one embodiment, the call invitation request may be closed by the management module based on either user instruction or predefined conditions. The request sending/receiving module then instructs the first terminal to send a signal to the second terminal, indicating that the call invitation request has been refused. If the second time period is set to be immediately succeeding the first time period, the call initiation command is activated immediately after the call invitation request is refused.

If the instruction detecting module does not detect the first predefined user operation that is interpreted as answering the call invitation request, the management module stops the call invitation request and instructs the displaying module to change the display. The display of the call invitation request is replaced with the display of the conversation request. Preferably, the conversation request includes a call initiation command that is set to expire after the second time period.

After the first time period and within the second time period, when a user wants to call the second terminal, he/she can also choose to perform a predefined user operation on the call initiation command. The instruction detecting module then detects a second predefined user operation and interprets it into a predefined instruction. The management module receives the predefined instruction and finds that the call initiation command has not expired. As a result the management module determines the instruction to be a valid instruction to initiate a call to the second terminal at step S1304. The request sending/receiving module then calls or sends a call invitation request to the second terminal at step S1312. In one embodiment, the management model does not activate the call initiation command again if the second terminal answers the call and a call connection is established and then terminated subsequently.

After the second time period, the management module stops the call initiation command and instructs the displaying module to change the display. Preferably, the first terminal now indicates to the user that the call initiation command has now expired.

In one embodiment, if an instruction detecting module detects an operation after or outside of the second time period, the management module refuses to call the second terminal. The displaying module is instructed to indicate this refusal at step S1313. For example, the terminal can display a message saying “Sorry, the time to call has passed.”

Through description of the foregoing embodiments, a responsive conversation is adopted in the embodiments of the present invention. When a call response of a called end (that is, a second terminal) is not received within certain time, prompt information that a call is not connected is output in a calling end (that is, a first terminal), which can enable a user of the calling end to know an actual reason of a call failure, avoid long-time occupation of communication resources, and save the time of both parties of the conversation. In addition, in the embodiment of the present invention, before the calling end initiates a call request, a call right of the calling end is verified, thereby preventing call disturbance to the called end, and improving intelligence of a conversation process. Moreover, in the responsive conversation process of the embodiments of the present invention, when a user of a called end does not perform a response operation for a call request of a calling end within certain time, callback prompt information is output in the called end, and a communication connection between the calling end and the called end is established in a callback manner, thereby relieving an answering pressure of the user of the called end, providing more sufficient time for establishing a conversation process, saving waiting time of both parties of a conversation, and improving communication efficiency.

Persons of ordinary skill in the art should understand that all or a part of the steps of the method according to the embodiments may be implemented by a computer program instructing relevant hardware. The program may be stored in a computer readable storage medium. When the program is run, the steps of the method according to the embodiments are performed. The storage medium may be a magnetic disk, an optical disk, a Read-Only Memory (ROM), or a Random Access Memory (RAM).

The foregoing merely is an exemplary embodiment of the present invention, which cannot be used to limit the protection scope of the present invention. Therefore, the equivalent variation made based on claims of the present invention shall fall within the scope of the present invention.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present invention. First ranking criteria and second ranking criteria are both ranking criteria, but they are not the same ranking criteria.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain principles of the invention and its practical applications, to thereby enable others skilled in the art to best utilize the invention and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A method of conversation, comprising:
at a first mobile communication terminal having one or more processors and memory:
receiving a conversation request from a second mobile communication terminal, wherein the conversation request contains a call invitation request that expires after a first time period;
displaying the call invitation request;
establishing a call connection with the second mobile communication terminal in response to detecting a first predefined user operation on the call invitation request within the first time period;
replacing the display of the call invitation request with the display of the conversation request after the first time period, the conversation request further including a call initiation command that expires after a second time period; and
initiating a call to the second mobile communication terminal if detecting a second predefined user operation on the call initiation command after the first time period and within the second time period, wherein the second time period is longer than the first time period.

2. The method of claim 1, wherein the conversation request is displayed along with text, image, audio, or video information received by the first mobile communication terminal.

3. The method of claim 2, wherein the text, image, audio, or video information is all sent from the second mobile communication terminal.

4. The method of claim 2, wherein the text, image, audio, or video information is all sent from two or more different mobile communication terminals.

5. The method of claim 1, further comprising:
before the call initiation command expires, refusing to initiate a call to the second mobile communication terminal in response to detecting a predefined user operation on the call initiation command.

6. The method of claim 1, wherein the lengths of the first time period and the second time period are both set by the user of the second mobile communication terminal.

7. The method of claim 1, wherein the first predefined user operation is the same with the second predefined user operation.

8. The method of claim 1, wherein the second predefined user operation is selecting an icon displayed in the conversation request.

9. A first mobile communication terminal, comprising:
one or more processors; and
memory for storing one or more program modules, wherein the one or more program modules, when executed by the one or more processors, cause the first mobile communication terminal to:
receive a conversation request from a second mobile communication terminal, wherein the conversation request contains a call invitation request that expires after a first time period;
display the call invitation request;
establish a call connection with the second mobile communication terminal in response to detecting a first predefined user operation on the call invitation request within the first time period;
replace the display of the call invitation request with the display of the conversation request after the first time period, the conversation request further including a call initiation command that expires after a second time period; and
initiate a call to the second mobile communication terminal if detecting a second predefined user operation on the call initiation command after the first time period and within the second time period, wherein the second time period is longer than the first time period.

10. The first mobile communication terminal of claim 9, wherein the conversation request is displayed along with text, image, audio, or video information received by the second mobile communication terminal.

11. The first mobile communication terminal of claim 10, wherein the text, image, audio, or video information is all sent from the second mobile communication terminal.

12. The first mobile communication terminal of claim 10, wherein the text, image, audio, or video information is all sent from two or more different mobile communication terminals.

13. The first mobile communication terminal of claim 9, wherein the one or more program modules further include instructions for:
before the call initiation command expires, refusing to initiate a call to the second mobile communication terminal in response to detecting a predefined user operation on the call initiation command.

14. The first mobile communication terminal of claim 9, wherein the lengths of the first time period and the second time period are both set by the user of the second mobile communication terminal.

15. The first mobile communication terminal of claim 9, wherein the first predefined user operation is the same with the second predefined user operation.

16. The first mobile communication terminal of claim 9, wherein the second predefined user operation is selecting an icon displayed in the conversation request.

17. A non-transitory computer readable storage medium storing one or more program modules configured for execution by a first mobile communication terminal that includes one or more processors, the one or more program modules including instructions for:
receiving a conversation request from a second mobile communication terminal, wherein the conversation request contains a call invitation request that expires after a first time period;
displaying the call invitation request;
establishing a call connection with the second mobile communication terminal in response to detecting a first predefined user operation on the call invitation request within the first time period;
replacing the display of the call invitation request with the display of the conversation request after the first time period, the conversation request further including a call initiation command that expires after a second time period; and
initiating a call to the second mobile communication terminal if detecting a second predefined user operation on the call initiation command after the first time period and within the second time period, wherein the second time period is longer than the first time period.
